(19) United States
(12) Patent Application Publication
(10) Pub. No.: US 2007/0164702 A1
(43) Pub. Date: Jul. 19, 2007

(54) Battery cross-reference method and system

(75) Inventor: Ramin Salehi, Frisco, TX (US)

Correspondence Address: HAYNES AND BOONE, LLP, 901 MAIN STREET, SUITE 3100, DALLAS, TX, 75202, US

(73) Assignee: Universal Power Group, Carrollton, TX (US)

(21) Appl. No.: 11/331,950

(22) Filed: Jan. 13, 2006

(51) Int. Cl. H02J 7/00

(52) U.S. Cl. 320/106

(57) ABSTRACT

Aspects of the present invention provide a method and a system for handling cross-reference of batteries. A battery cross-reference system is provided for users of all levels of knowledge to search for a battery based on different attributes of a battery. The different attributes of a battery includes a chemistry, a category, a brand of the category, a brand model, a manufacturer, a battery model and other attributes.

### BACKGROUND

Current observation of the battery industry and customer data analysis indicate a challenge of determining suitable batteries for a particular device, such as mobile phone handsets, watches, radios, cameras, scooters, motorcycles, all terrain vehicles, and the like. In particular, it is often difficult for ordinary consumers to identify the right battery without the knowledge of specific battery information, such as a stock number. Conversely, it may be difficult for a battery specialists or distributors to identify a battery without the knowledge of a brand or a model number of the device. A need exists for a single source of information that can handle different attributes of batteries, such that both inexperienced consumers and battery specialists may identify the right battery. In addition, a need exists for an integration of the single source of information with front-end systems, such as point-of-sale terminals, kiosks, or e-commerce websites. In this way, users of all levels of knowledge may easily and quickly identify and purchase the right battery for the particular device.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram illustrating a three-tiered architecture of an embodiment of a battery cross-reference system and method;

FIG. 2 is a simplified block diagram illustrating a two-tiered architecture of an embodiment of a battery cross-reference system and method;

FIG. 3 is an entity diagram of an embodiment of a battery cross-reference system and method;

FIG. 4 is a more detailed entity diagram of an embodiment of a battery cross-reference system and method;

FIG. 5 is an exemplary entity relationship diagram of an embodiment of a battery cross-reference system and method;

FIGS. 6A-6C are diagrams of an embodiment of database tables and field definitions of a battery cross-reference system;

FIG. 7 is a process flowchart of an embodiment of a battery cross-reference method;

FIG. 8A is an exemplary screen shot of a main page of a battery cross-reference system;

FIG. 8B is an exemplary screen shot of a “select a category” page of a battery cross-reference system;

FIG. 8C is an exemplary screen shot of a “select a brand name” page of a battery cross-reference system;

FIG. 8D is an exemplary screen shot of a “select a brand model” page of a battery cross-reference system;

FIG. 8E is an exemplary screen shot of a result page of a battery cross-reference system;

FIG. 9A is an exemplary screen shot of a “select a chemistry” page of a battery cross-reference system;

FIG. 9B is an exemplary screen shot of a “select a manufacturer” page of a battery cross-reference system;

FIG. 9C is an exemplary screen shot of a “select a battery model” page of a battery cross-reference system; and

FIG. 9D is an exemplary screen shot of a result page of a battery cross-reference system.

### DETAILED DESCRIPTION

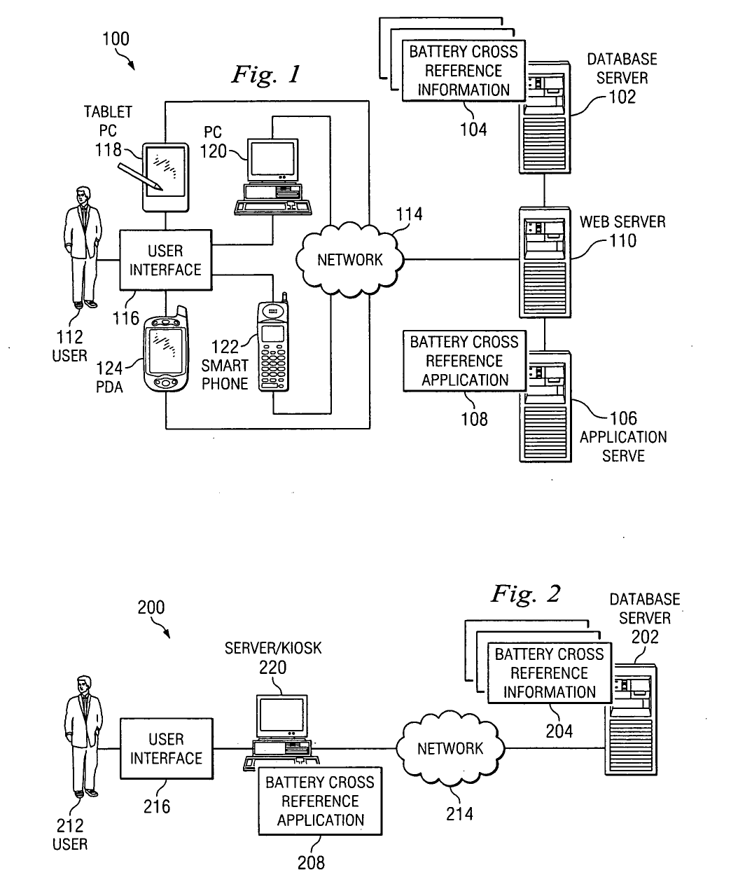

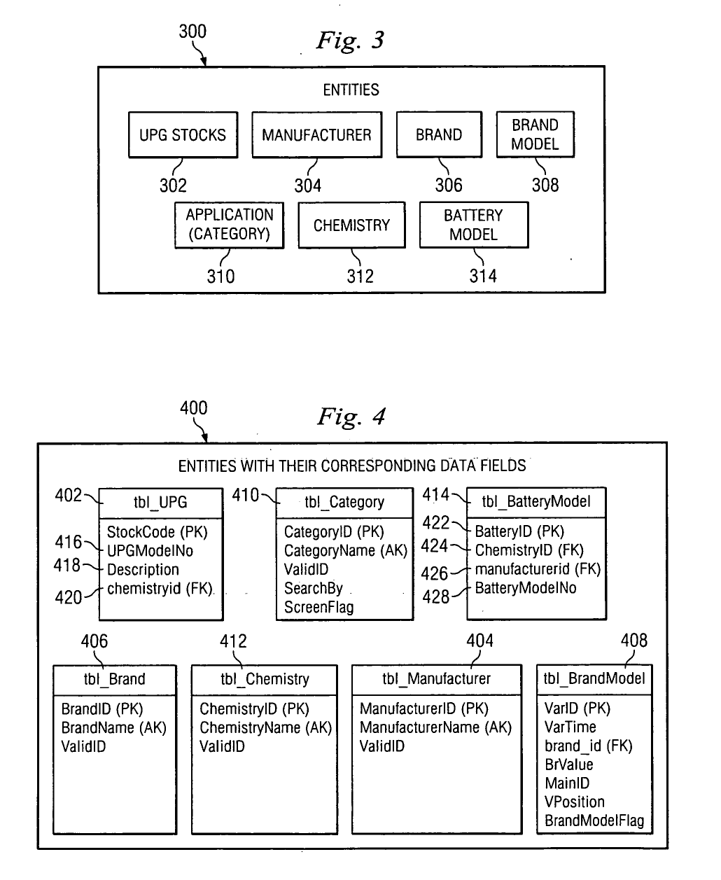

FIG. 1 is a simplified block diagram illustrating a three-tiered architecture of an embodiment of a battery cross-reference system and method. Battery cross-reference system 100 of the present invention may be implemented utilizing a three-tiered architecture as shown. The first tier is a database server 102, in which a plurality of tables containing battery cross-reference information 104 is stored. More details regarding battery cross-reference information 104 are discussed below with reference to in FIGS. 3, 4, and 5.

The second tier is an application server 106, in which a battery cross-reference application 108 resides. Battery cross-reference application 108 analyzes information received from a Web server 110 and executes queries necessary in database server 102 to lookup the right battery for a user 112. The third tier is Web server 110, which receives input from user 112 remotely over a network 114. Network 114 is a medium used to provide communication links between various devices and computers connected together within database information system 100. Network 114 may include connections, such as wired, wireless communication links, or fiber optic cables. Network 114 may be the Internet representing a worldwide collection of networks and gateways that use the Transmission Control Protocol/Internet Protocol (TCP/IP) suite of protocols to communicate with one another. Network 114 may also be implemented as a number of different types of networks, such as, for example, an intranet, a local area network (LAN), or a wide area network (WAN). FIG. 1 is intended as an example, and not as an architectural limitation for different embodiments of the present invention.

In operation, user 112 sends search criteria for identifying a battery brand, model, or part number via a user interface 116. User interface 116 may be implemented as a software application executing within a number of devices. In this exemplary implementation, user interface 116 may be implemented as a Web application executing within a tablet personal computer (PC) 118, a client personal computer 120, a smart phone 122, or a personal digital assistant (PDA) 124. In addition, user interface 116 may be implemented within other types of devices without departing the spirit and scope of the present invention.

FIG. 2 is a simplified block diagram illustrating a two-tiered architecture of an embodiment of a battery cross-reference system and method. Battery cross-reference system 200 of the present invention may be implemented utilizing a two-tiered architecture as shown. The first tier is a database server 202, in which a plurality of tables containing battery cross-reference information 204 is stored. More details regarding battery cross-reference information 204 are discussed below with reference to in FIGS. 3, 4, and 5.

The second tier is a server/kiosk 220. Server/kiosk 220 may be implemented as a client computer or a server. Server/kiosk 220 comprises a battery cross-reference application 208, which analyzes information received from a user interface 216 and executes queries in database server 202 to lookup the right battery for a user 212. In this exemplary implementation, queries are executed remotely over a network 214. Network 214 may be implemented as the Internet, an intranet, a local area network (LAN), or a wide area network (WAN).

In operation, user 212 may input search criteria for identifying a battery brand, model, or part number via user interface 216. User interface 216 may be implemented as a software application executing within server/kiosk 220 in conjunction with battery cross-reference application 208 or as a part of battery cross-reference application 208. Server/kiosk 220 includes a monitor screen that may be touch-sensitive, and/or other user input devices such as a keyboard or keypad. In addition to a server/kiosk 220, user interface 216 and battery cross-reference application 208 may be implemented within other types of devices without departing the spirit and scope of the present invention. For example, a device such as a point-of-sale terminal may be used.

As described above, the battery cross-reference system of the present invention provides cross-reference links between batteries that are manufactured by different manufactures or suppliers. In order to abstract battery attributes that apply across these different manufacturers or suppliers, both general and specific properties of all battery chemistries are examined.

FIG. 3 is an entity diagram of an embodiment of a battery cross-reference system and method. As shown in FIG. 3, entities 300 are derived based on analysis of different battery applications and manufacturers' data. In this example, entities 300 include universal power group (UPG) stock numbers 302, manufacturers of the battery 304, brands of the battery category 306, brand models of the battery category 308, applications or categories for which batteries are used 310, chemistries of batteries 312, and battery models 314. A brand model indicates a brand model of the device in which the battery is used, for example, a brand model “6100” for cellular phone brand “Nokia”. On the other hand, a battery model indicates a model of the battery available from the manufacturer, for example, model “6AM6” from manufacturer “Panasonic.”

FIG. 4 is a more detailed entity diagram of an embodiment of a battery cross-reference system and method. As shown in FIG. 4, data related to each of the entities is stored in a table in the database. In this example, table tbl_UPG 402 stores data related to UPG stocks 302 in FIG. 3. Table tbl_Manufacturer 404 stores data related to manufacturer 304 in FIG. 3. Table tbl_Brand 406 stores data related to brand 306 in FIG. 3. Table tbl_BrandModel 408 stores data related to brand model 308 in FIG. 3. Table tbl_Category 410 stores data related to category 310 in FIG. 3. Table tbl_Chemistry 412 stores data related to chemistry 312 in FIG. 3. Table tbl_BatteryModel 414 stores data related to battery model 314 in FIG. 3.

Each entity table includes a list of pertinent data fields. These data fields have direct or indirect relationships with the entity. For example, table tbl_UPG 402 includes data fields UPGModelNo 416, description 418, and chemistryid 420. UPGModelNo 416 and Description 418 are directly related to UPG stocks 302 while chemistryid 420 is related to table tbl_Chemistry 412, which represents Chemistry 312. Similarly, table tbl_BatteryModel 414 includes data fields BatteryID 422, ChemistryID 424, manfacturerid 426, and BatteryModelNo 428. BatteryID 422 and BatteryModelNo 428 are directly related to Battery Model 314, while ChemistryID 424 and manfacturerid 426 are related to table tbl_Chemistry 412 and table tbl_Manufacturer 404, respectively.

In order to avoid many-to-many relationships between the entities, the aspect of the present invention resolves these relationships using link tables. Link tables resolve many-to-many relationships by providing a mapping of one specific entity to another specific entity, for example, a mapping of a specific battery model number to a specific stock code. In this way, data fields associated with the other specific entity may easily be retrieved.

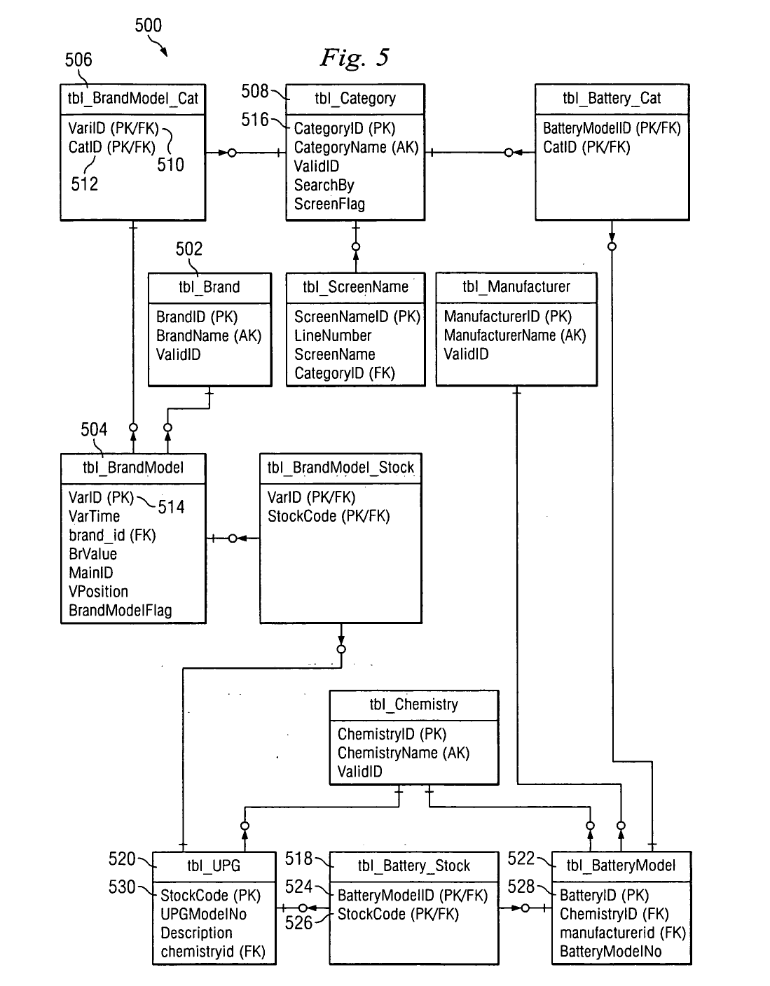

FIG. 5 is an exemplary entity relationship diagram of an embodiment of a battery cross-reference system and method. As shown in FIG. 5, entity relationship diagram 500 includes a plurality of tables as shown in FIG. 4 and relationships between the plurality of tables. For example, a relationship exists between table tbl_Brand 502 and table tbl_BrandModel 504.

In addition to the relationships between the plurality of tables, entity relationship diagram 500 also includes a number of link tables that resolve many-to-many relationships between the plurality of tables. As shown in FIG. 5, link table table tbl_BrandModel_Cat 506 resolves the many-to-many relationships between table tbl_BrandModel 504 and table tbl_Category 508 by including data fields VarIDPK 510 and CatID 512. VarIDPK 510 refers to data field VarID 514 in table tbl_BrandModel 504, while CatID 512 refers to data field CategoryID 516 in table tbl_Category 508.

Similarly, link table table tbl_Battery_Stock 518 resolves the many-to-many relationships between table tbl_UPG 520 and table tbl_BatteryModel 522 by including data fields BatteryModelID 524 and StockCode 526. BatteryModelID 524 refers to data field BatteryID 528 in table tbl_BatteryModel 522, while StockCode 526 refers to data field StockCode 530 in table tbl_UPG 520.

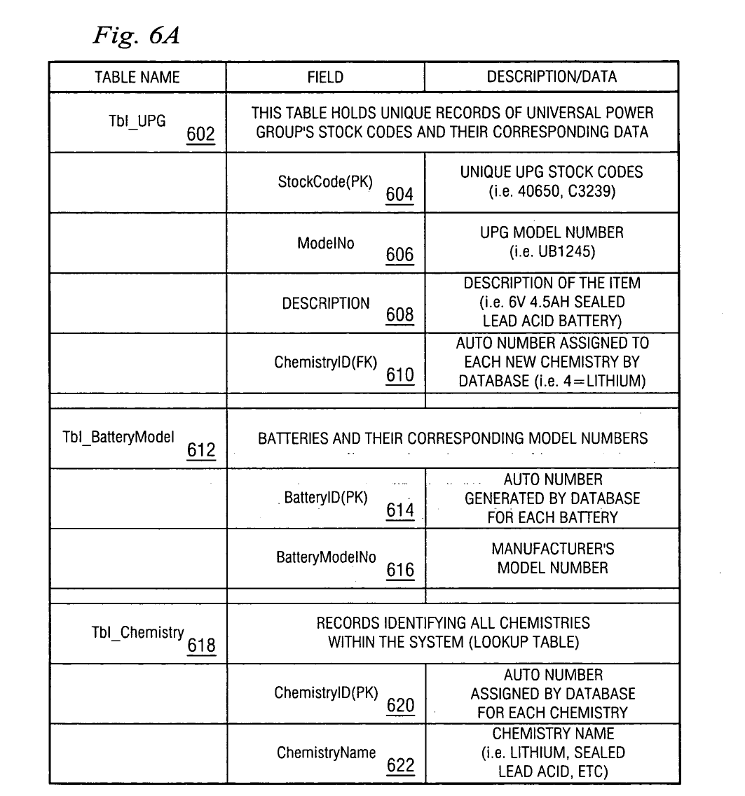

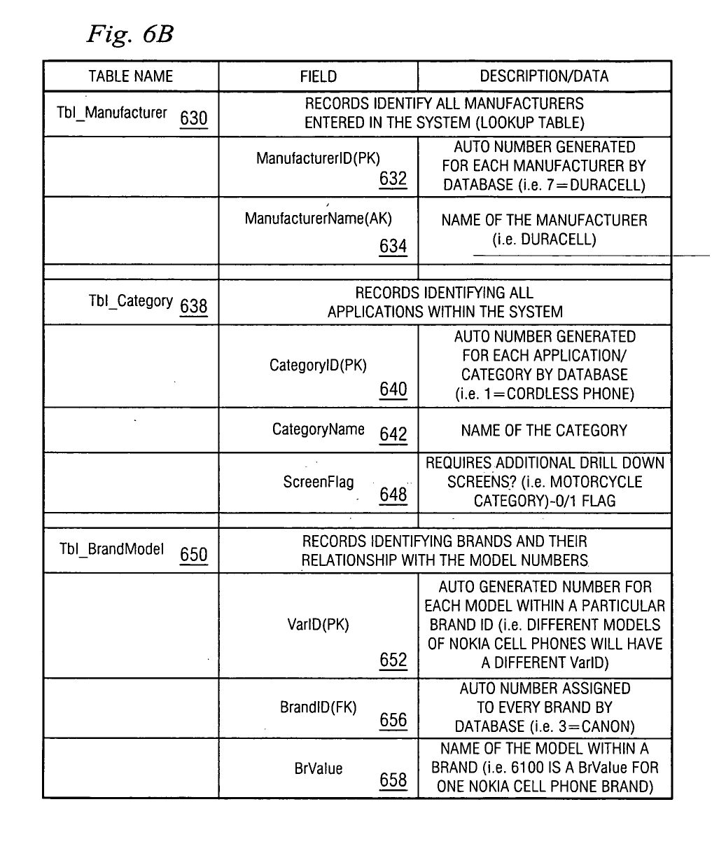

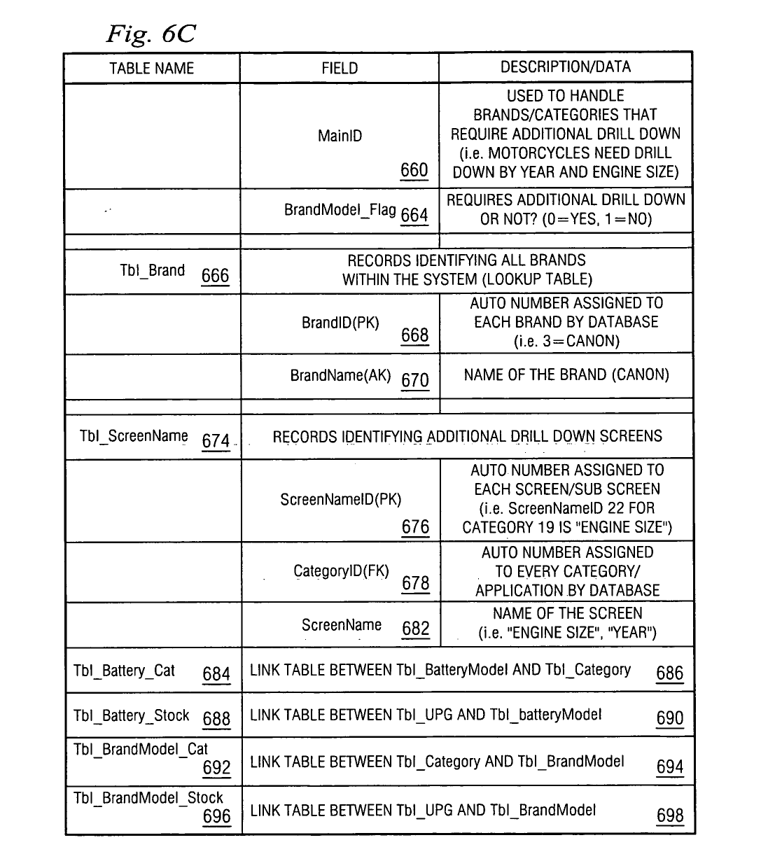

FIGS. 6A-6C are diagrams of an embodiment of database tables and field definitions of a battery cross-reference system. The tables and field definitions are defined in the database based on the entity relationships identified in entity relationship diagram 500 in FIG. 5. As shown in FIG. 6A, table tbl_UPG 602 includes unique records of the universal power group stock codes, StockCode 604, and corresponding data fields These data fields include ModelNo 606, Description 608, and ChemistryID 610. ModelNo 606 represents the universal power group model numbers, for example, “UB1245.” Description 608 represents description of the item, for example, “6V 4.5 AH sealed lead acid battery.” ChemistryID 610 represents an auto number that is assigned to each new chemistry by the database, for example, a number “4” is assigned to “lithium.”

Table tbl_BatteryModel 612 includes batteries and their corresponding model numbers. For example, BatteryID 614 is a unique identifier assigned to each battery and BatteryModelNo 616 is a manufacturer's model number assigned to each battery model. Table tbl_Chemistry 618 includes records identifying all chemistries within the system. Each chemistry is assigned a unique ChemistryID 620 and each ChemistryID 620 is associated with a ChemistryName 622, for example, “lithium,” “sealed lead acid,” and the like.

Turning now to FIG. 6B, table tbl_Manufacturer 630 includes records identifying all manufacturers within the system. Each manufacturer is assigned a ManufacturerID 632, for example, a number “7” for “Duracell.” In addition, each manufacturer is assigned a manufacturerName 634 identifying the name of the manufacturer. An example of manufacturerName 634 is “Duracell.”

Table tbl_Category 638 includes records identifying all applications for which the battery is used. Each application is assigned a CategoryID 640, for example, a number “1” for cordless phone, and a CategoryName 642 identifying the name of the application. In addition, table tbl_Category 638 includes a ScreenFlag 648 indicating whether additional drill-down screens are required. If the ScreenFlag 648 is set to 1, additional drill-down screens are presented in the user interface for the user to identify a subcategory.

Table tbl_BrandModel 650 includes records identifying brands of the battery and their relationship with the battery model numbers. Each model of a brand is assigned a unique VarID 652. For example, each model of “Nokia” cellular phones is assigned a unique VarID 652. In addition, table tbl_BrandModel 650 includes BrandID 656 and BrValue 658. BrandID 656 is assigned to every brand in the database, for example, a number “3” for “Canon” brand. BrValue 658 indicates the name of the model within a brand, for example, “6100” is a model number of “Nokia” cellular phones.

Turning now to FIG. 6C, table tbl_BrandModel 650 from FIG. 6B also includes MainID 660, which indicates whether the particular brand or category requires additional drill-down screens. For example, a motorcycle may need additional drill-down screens for the user to select specific year and engine size. Furthermore, table tbl_BrandModel 650 from FIG. 6B includes BrandModel_Flag 664. BrandModel_Flag 664 indicates whether additional drill-down screens are required for the particular brand model.

Table tbl_Brand 666 includes records identifying all brands that are within the system. Each brand is assigned a BrandID 668, for example, a number “3” for “Canon.” In addition, the brand name is indicated in BrandName 670, for example, “Canon.”

Table tbl_ScreenName 674 includes records identifying additional drill-down screens. Each drill-down screen is assigned a ScreenNameID 676, for example, a ScreenNameID “22” is assigned a drill-down screen for category 19 named “engine size”. Each drill-down screen is also associated with a CategoryID 678 and a ScreenName 682. CategoryID 678 identifies the drill-down screen to which the application is associated. ScreenName 682 describes the name of the drill-down screen, for example, “engine size” or “year.”

As discussed above, a number of link tables are created by the aspect of the present invention to resolve many-to-many relationships between the plurality of tables. In FIG. 6C, a number of link tables are shown. Table tbl_Battery_Cat 684 is a link table that resolves many-to-many relationships between table tbl_BatteryModel 612 and table tbl_Category 638. Table tbl_Battery_Stock 688 is a link table that resolves many-to-many relationships between table tbl_BatteryModel 612 and table tbl_UPG 602. Table tbl_BrandModel_Cat 692 is a link table that resolves many-to-many relationships between table tbl_BrandModel 650 and table tbl_Category 2638. Table tbl_BrandModel_Stock 696 is a link table that resolves many-to-many relationships between table tbl_BrandModel 650 and table tbl_UPG 602.

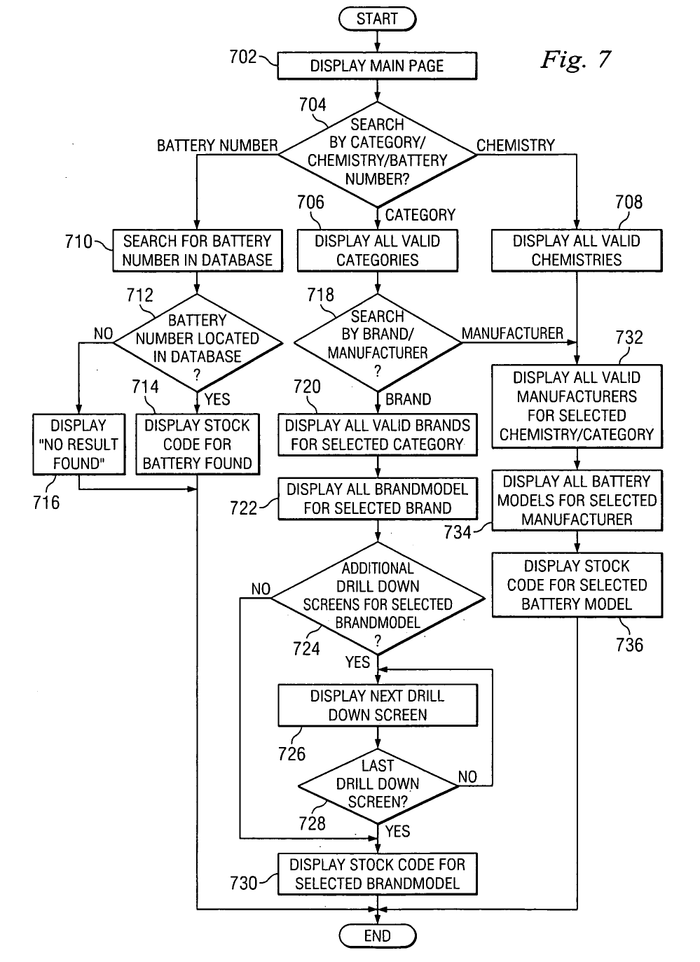

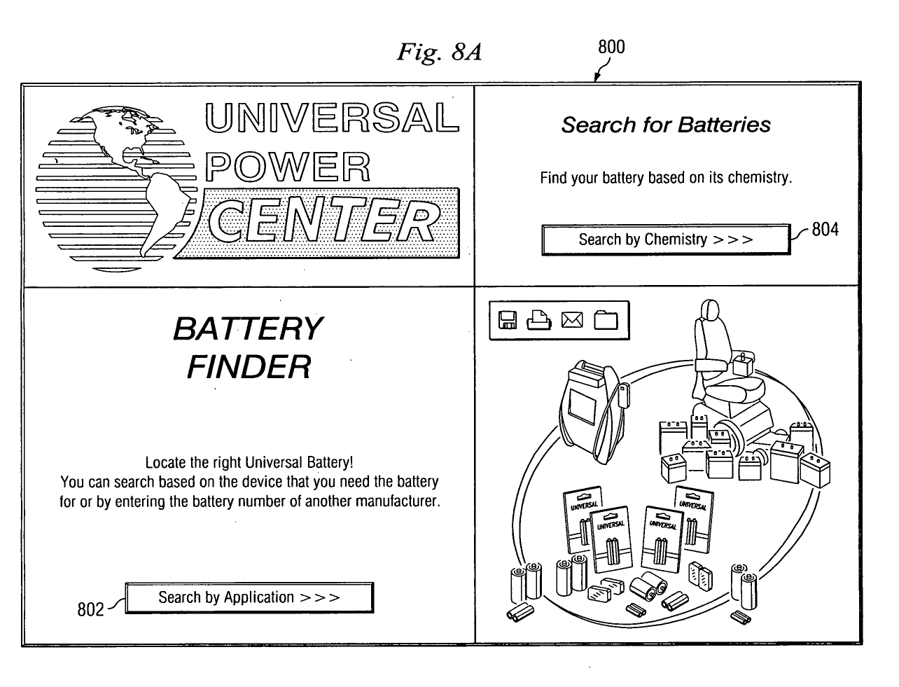

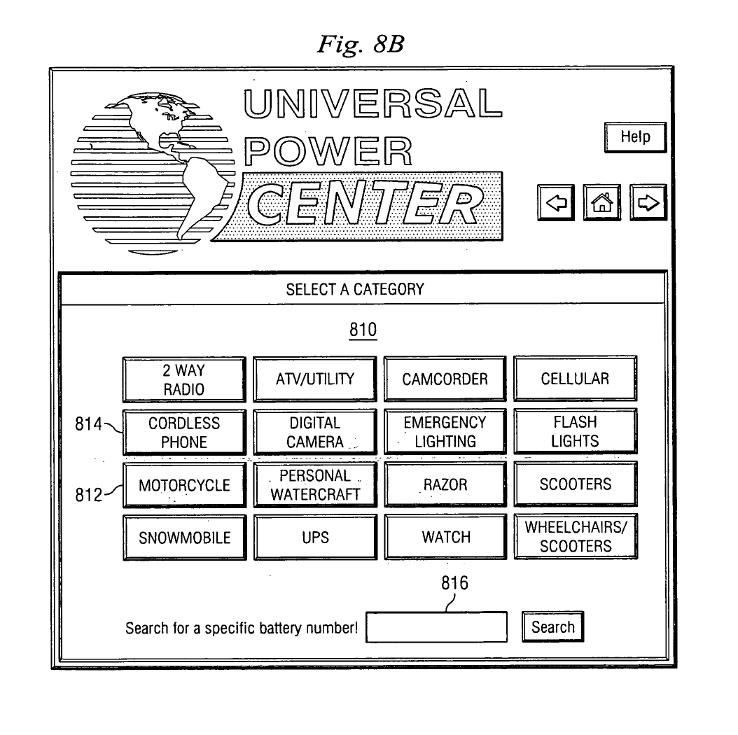

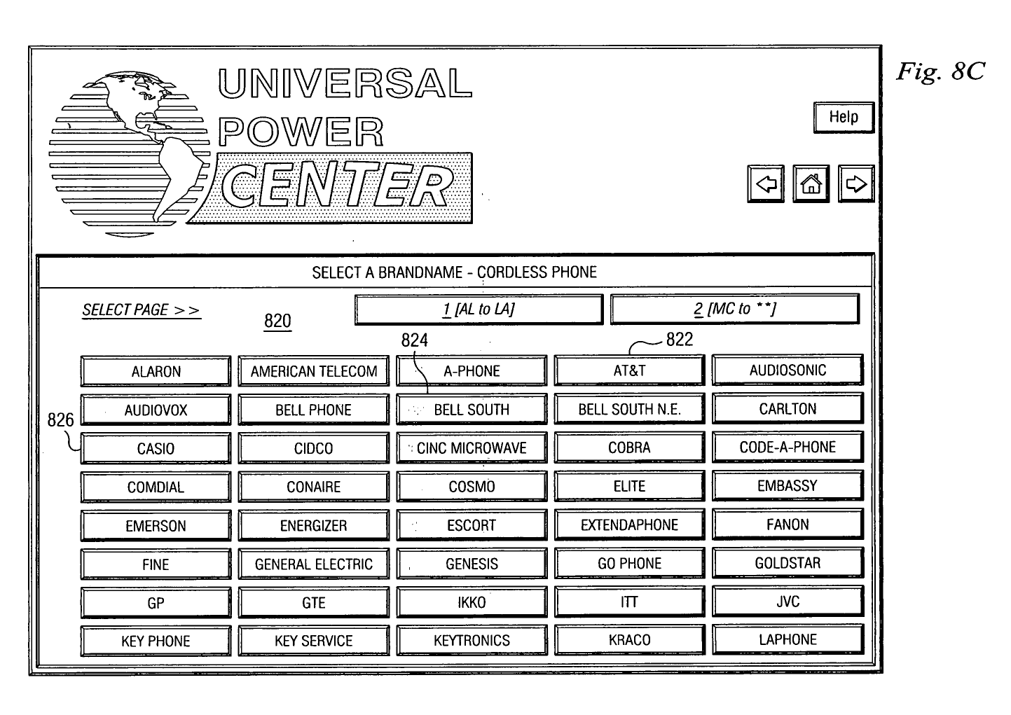

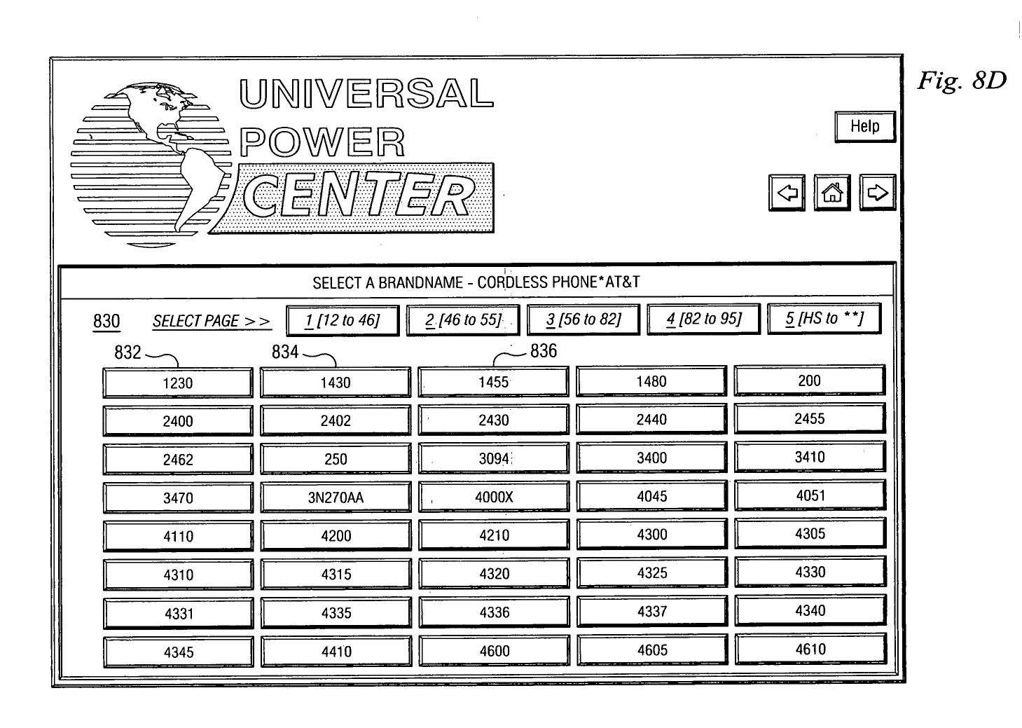

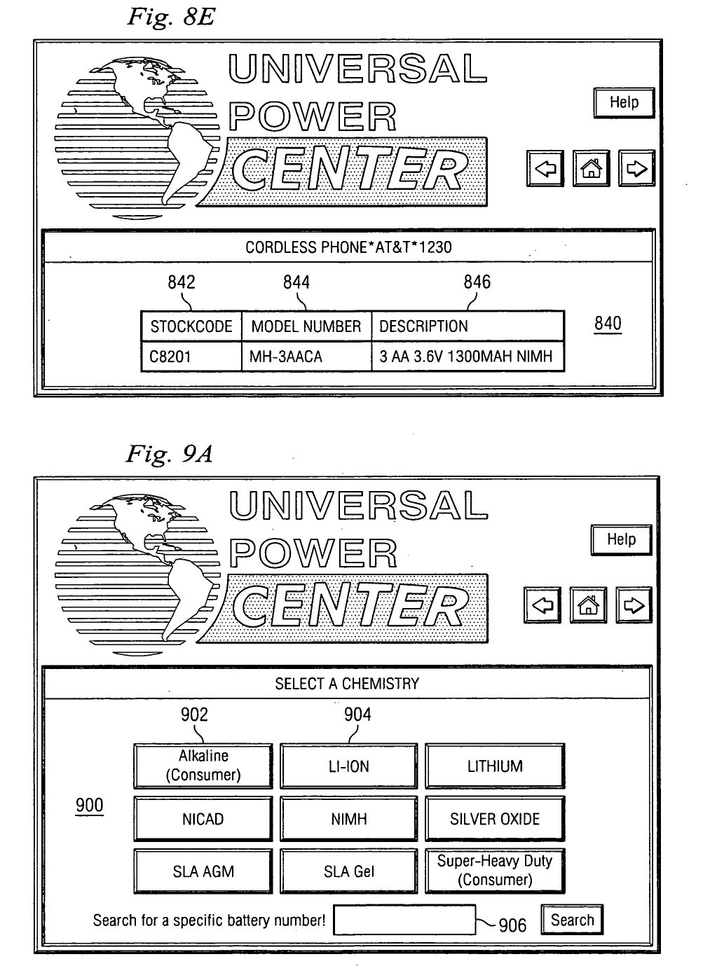

FIG. 7 is a process flowchart of an embodiment of a battery cross-reference method. This exemplary process may be implemented within a battery cross-reference application, such as battery cross-reference application 108 executing within an application server 106 in FIG. 1, or battery cross-reference application 208 executing within server/kiosk 220 in FIG. 2. From the perspective of the battery cross-reference application, the process begins when a main page is displayed (step 702). The main pager offers a search to the user based on the battery chemistry, battery category or battery number. More details regarding the main page are discussed below with reference to in FIG. 8A. Next, a determination is made as to whether the user selects a search by battery category, battery chemistry, or battery number (step 704).

If the user selects to search by the battery number, the process performs a search for the battery number entered by the user in the database (step 710) and a determination is made as to whether the battery number is identified in the database (step 712). This step is performed by examining table tbl_UPG 502 in FIG. 6A. If the battery number is identified, the stock code for the battery found is displayed (step 714) and the process terminates thereafter. However, if the battery number is not identified, a “no result found” message is displayed (step 716) and the process terminates thereafter.

Turning back to step 704, if the user selects to search by the battery category, all valid categories in the database are displayed (step 706). This step is performed by examining table tbl_Category 638 in FIG. 6B. More details regarding a “select a category” page are discussed below with reference to in FIG. 8B. Once a user selects a category from all valid categories, a determination is made as to whether the user selects to search by the category brand or the battery manufacturer (step 718). If the user selects to search by the battery manufacturer, the process continues to step 732. However, if the user selects to search by the category brand, all valid brands for the selected category is displayed (step 720). This step is performed by examining table tbl_Brand 666 in FIG. 6C. More details regarding a “select a brand name” page are discussed below with reference to in FIG. 8C. Subsequently, once a brand is selected by the user, all brand models for the selected category brand is displayed (step 722). This step is performed by examining table tbl_BrandModel 650 in FIG. 6B. More details regarding a “select a brand model” page are discussed below with reference to in FIG. 8D. A determination is then made as to whether additional drill-down screens are present in the database for the selected brand model (step 724). This step may be performed by examining BrandModel_Flag 664 in FIG. 6C. Examples of additional drill-down screens for a motorcycle category include year, engine size, and the like.

If no additional drill-down screens are present in the database for the selected brand model, the process continues to step 730. If additional drill-down screens are present in the database for the selected brand model, the next drill-down screen is displayed (step 726). Next, a determination is made as to whether the next drill-down screen is the last drill-down screen (step 728). If the next drill-down screen is not the last drill-down screen, the process returns to step 726 to display the next drill-down screen. However, if the next drill-down screen is the last drill-down screen, the stock code for the selected brand model is displayed once the brand model is selected by the user (step 730). This step is performed by using table tbl_BrandModel_Stock link table 696 in FIG. 6C. More details regarding a result page in which the stock code is displayed are discussed below with reference to in FIG. 8E. Thus, the process terminates thereafter.

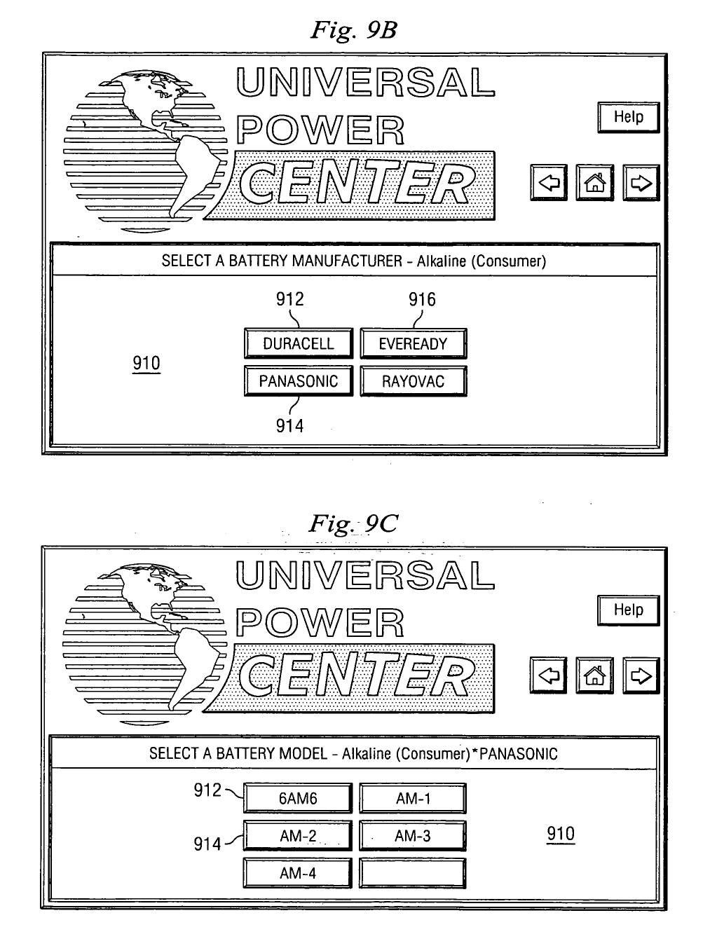

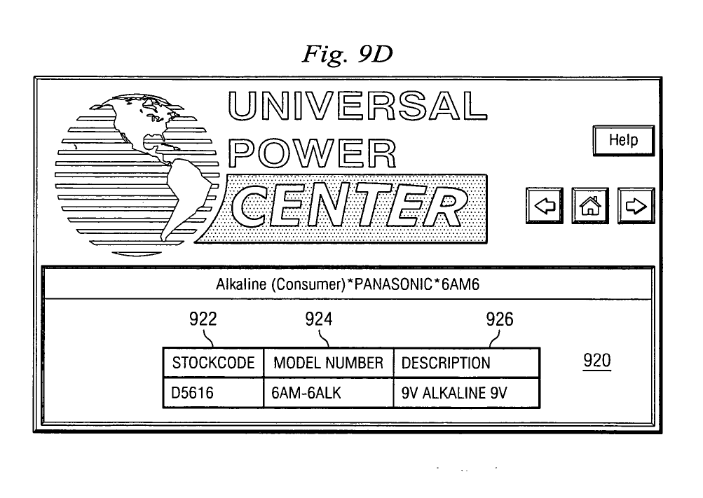

Turning back to step 704, if the user selects to search by the battery chemistry, all valid battery chemistries in the database are displayed (step 708). This step is performed by examining table tbl_Chemistry 618 in FIG. 6A. More details regarding a “select a chemistry” page are discussed below with reference to in FIG. 9A. At step 732, once the user selects a battery chemistry, all valid battery manufacturers for the selected battery chemistry or battery category are displayed. This step is performed by examining table tbl_Manufacturer 630 in FIG. 6B. More details regarding a “select a manufacturer” page are discussed below with reference to in FIG. 9B. Subsequently, once the user selects a battery manufacturer, all battery models for the selected battery manufacturer are displayed (step 734). This step is performed by examining table tbl_BatteryModel 612 in FIG. 6A. More details regarding a “select a battery model” page are discussed below with reference to in FIG. 9C. Finally, once the user selects a battery model, the stock code for the selected battery model is displayed (step 736) and the process terminates thereafter. This step is performed by using table tbl_Battery_Stock link table 688 in FIG. 6C. More details regarding a result page in which the stock code is displayed are discussed below with reference to in FIG. 9D.

FIG. 8A is an exemplary screen shot of a main page of a battery cross-reference system. As shown in FIG. 8A, main page 800 is part of a searchable battery cross-reference application provided by the present invention, such as battery cross-reference application 108 executing within application server 106 in FIG. 1, or battery cross-reference application 208 executing within server/kiosk 220 in FIG. 2. In this exemplary implementation, main page 800 allows a user to select a search of battery by battery category 802 or by battery chemistry 804.

FIG. 8B is an exemplary screen shot of a “select a category” page of a battery cross-reference system. As shown in FIG. 8B, after the user selects to search by category 802 on main page 800 in FIG. 8A, a list of battery categories from the database is displayed in a “select a category” page 810. The list of battery categories are applications for which a battery is used, for example, motorcycle 812 and cordless phone 814. In addition, a user may enter a battery number on this page to perform a search 816.

FIG. 8C is an exemplary screen shot of a “select a brand name” page of a battery cross-reference system. As shown in FIG. 8C, if the user selects a battery category from “select a category” page 810 in FIG. 8B, a list of brand names for the selected battery category is displayed in “select a brand name” page 820. In this example, “select a brand name” page 820 displays a list of brands for selected category cordless phone 820. Examples of these brands include AT&T 822, Bell South 824, and Casio 826.

FIG. 8D is an exemplary screen shot of a “select a brand model” page of a battery cross-reference system. As shown in FIG. 8D, after the user selects a brand from “select a brand name” page 820 in FIG. 8C, a list of brand models for the selected brand name is displayed in “select a brand model” page 830. In this example, “select a brand model” page 830 displays a list of brand models for selected brand name AT&T 822. Examples of these brand models include 1230 model 832, 1430 model 834, and 1455 model 836.

FIG. 8E is an exemplary screen shot of a result page of a battery cross-reference system. As shown in FIG. 8E, after the user selects a brand model from “select a brand model” page 830 in FIG. 8D, a stock number of the battery for the selected brand model is displayed in a result page 840. In this example, result page 840 displays a stock code 842, a model number 844, and a description 846 for selected 1230 model 832. For example, the battery for selected 1230 model has a stock code 842 of “C8201,” a model number 844 of “MH-3AACA,” and a description 846 of “3AA 3.6V 1300MAH NIMH.”

FIG. 9A is an exemplary screen shot of a “select a chemistry” page of a battery cross-reference system. As shown in FIG. 9A, after the user selects to search by chemistry 804 on main page 800 in FIG. 8A, a list of battery chemistries from the database is displayed in a “select a chemistry” page 900. The list of battery chemistries are battery chemistry types, for example, “Alkaline” 902 and “LI-ION” 904. In addition, a user may enter a battery number on this page to perform a search 906.

FIG. 9B is an exemplary screen shot of a “select a manufacturer” page of a battery cross-reference system. As shown in FIG. 9B, if the user selects a battery chemistry from “select a chemistry” page 900 in FIG. 9A, a list of battery manufacturers for the selected chemistry is displayed in “select a battery manufacturer” page 910. In this example, “select a battery manufacturer” page 910 displays a list of battery manufacturers for selected battery chemistry, “Alkaline” 902. Examples of these battery manufacturers include “Duracell” 912, “Panasonic” 914, and “Eveready” 916.

FIG. 9C is an exemplary screen shot of a “select a battery model” page of a battery cross-reference system. As shown in FIG. 9C, after the user selects a battery manufacturer from “select a battery manufacturer” page 910 in FIG. 9B, a list of battery models for the selected battery manufacturer is displayed in “select a battery model” page 910. In this example, “select a battery model” page 910 displays a list of battery models for selected battery manufacturer “Panasonic” 914. Examples of these battery models include “6AM6” model 912 and “AM-2” model 914.

FIG. 9D is an exemplary screen shot of a result page of a battery cross-reference system. As shown in FIG. 9D, after the user selects a battery model from “select a battery model” page 910 in FIG. 9C, a stock number of the battery for the selected battery model is displayed in a result page 920. In this example, result page 920 displays a stock code 922, a model number 924, and a description 926 for selected 6AM6 model 912. For example, the battery for selected “6AM6” model has a stock code 922 of “D5616,” a model number 924 of “6AM-6ALK,” and a description 926 of “9V Alkaline 9V.”

In summary, aspects of the present invention provide a searchable information system for handling cross-reference of batteries. With the aspects of the present invention, ordinary consumers and battery specialists may identify the right battery for a particular device regardless of their battery knowledge. In this way, users of all levels of experience may easily and quickly identify the right battery for the particular device.

The present invention can take the form of an entirely hardware embodiment, an entirely software embodiment, or an embodiment containing both hardware and software elements. In an illustrative embodiment, the invention is implemented in software, which includes but is not limited to firmware, resident software, microcode, etc.

Furthermore, the invention can take the form of a computer program product accessible from a tangible computer-usable or computer-readable medium providing program code for use by or in connection with a computer or any instruction execution system. For the purposes of this description, a tangible computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, a semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital video disc (DVD).

Although embodiments of the present disclosure have been-described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A battery cross-reference method, the method comprising:
providing a search by at least one of battery chemistry, battery category, and battery number; and
responsive to receiving a user selection of a search by battery category, displaying a list of battery categories from a database.

2. The method of claim 1, further comprising:
responsive to receiving a user selection of a search by battery chemistry, displaying a list of battery chemistries from the database.

3. The method of claim 1, further comprising:
responsive to receiving a user selection of a selected battery category from the list of battery categories, providing a search by at least one of category brand and battery manufacturer.

4. The method of claim 3, further comprising:
responsive to receiving a user selection of a search by the category brand, displaying a list of brands for the selected battery category; and
responsive to receiving a user selection of a selected brand from the list of brands, displaying a list of brand models for the selected brand.

5. The method of claim 4, further comprising:
responsive to receiving a user selection of a selected brand model from the list of brand models, identifying a battery for the selected brand model in the database; and
displaying a stock code of an identified battery from the database.

6. The method of claim 4, further comprising:
responsive to receiving a user selection of a selected brand model from the list of brand models, determining if additional search criteria screens are present;
if additional search criteria screens are present, displaying the additional search criteria screens;
responsive to receiving a user selection of a selected search criteria from the search criteria screens, identifying a battery for the selected search criteria in the database; and displaying a stock code of an identified battery from the database.

7. The method of claim 3, further comprising:
responsive to receiving a user selection of a search by the battery maufacturer, displaying a list of battery manufacturers for the selected battery category;
responsive to receiving a user selection of a selected battery manufacturer from the list of battery manufacturers, displaying a list of battery models for the selected battery manufacturer;
esponsive to receiving a user selection of a selected battery model from the list of battery models, identifying a battery for the selected battery model in the database; and
displaying a stock code of an identified battery from the database.

8. The method of claim 2, further comprising:
responsive to receiving a user selection a selected battery chemistry from the list of battery chemistries, displaying a list of battery manufacturers for the selected chemistry;
responsive to receiving a user selection of a selected battery manufacturer from the list of manufacturers, displaying a list of battery models for the selected battery manufacturer;
responsive to receiving a user selection of a selected battery model from the list of battery models, identifying a battery for the selected battery model in the database; and
displaying a stock code of an identified battery from the database.

9. The method of claim 2, further comprising:
responsive to receiving a user selection of a search by the battery number, identifying a battery for the battery number in the database; and
displaying a stock code of an identified battery from the database.

10. A battery cross-reference system comprising:
a database server comprising a database, a plurality of tables in the database, and a plurality of fields in the plurality of tables;
a Web server for receiving user inputs in a user interface of a device over a network; and
n application server comprising a battery cross-reference application, wherein the battery cross-reference application executes a query in the database to identify a battery based on user inputs received from the Web server.

11. The battery cross-reference system of claim 10, wherein data related to entities is stored in the plurality of tables , and wherein the entities represent applications and manufacturing data of batteries.

12. The battery cross-reference system of claim 10, wherein the plurality of tables comprise a stock number table, a battery model table, a battery chemistry table, a battery manufacturer table, a category table, a brand model table, a brand table, a screen name table, and a plurality of link tables.

13. The battery cross-reference system of claim 12, wherein the plurality of link tables resolve many-to-many relationships between the plurality of tables.

14. The battery cross-reference system of claim 11, wherein the plurality of fields are related to each of the entities.

15. An article of manufacture having encoded thereon a method having the steps of:
providing a search by at least one of battery chemistry, battery category, and battery number; and
responsive to receiving a user selection of a search by the battery category, displaying a list of battery categories from a database.

16. The article of manufacture of claim 15, wherein the method further comprises the steps of:
responsive to receiving a user selection of a search by the battery chemistry, displaying a list of battery chemistries from the database.

17. The article of manufacturer of claim 15, wherein the method further comprises the steps of:
responsive to receiving a user selection of a search by the battery number, identifying a battery for the battery number in the database; and
displaying a stock code of an identified battery from the database.

18. The article of manufacture of claim 15, wherein the method further comprises the steps of:
responsive to receiving a user selection of a selected battery category from the list of battery categories, providing a search by at least one of category brand and battery manufacturer.

19. The article of manufacture of claim 18, wherein the method further comprises the steps of:
responsive to receiving a user selection of a search by the category brand, displaying a list of brands for the selected battery category; and
responsive to receiving a user selection of a selected brand from the list of brands, displaying a list of brand models for the selected brand.

20. The article of manufacture of claim 20, wherein the method further comprises the steps of:
responsive to receiving a user selection of a selected brand model from the list of brand models, identifying a battery for the selected brand model in the database; and
displaying a stock code of an identified battery from the database.

21. A battery cross-reference system comprising:
a point-of-sale kiosk having a touch-sensitive screen;
a user interface displayed on the touch-sensitive screen; wherein the point-of-sale kiosk is coupled to a server via a network, the server having access to a battery cross-reference database, the database comprising:
a plurality of tables, wherein the plurality of tables comprise a stock number table, a battery model table, a battery chemistry table, a battery manufacturer table, a category table, a brand model table, a brand table;
a plurality of data fields in each of the plurality of tables; and
a plurality of link tables, wherein the plurality of link tables comprise:
a link table resolving a many-to-many relationship between the battery model table and the category table;
a link table resolving a many-to-many relationship between the battery model table and the stock number table;
a link table resolving a many-to-many relationship between the category table and the brand model table; and
a link table resolving a many-to-many relationship between the stock number table and the brand table.

22. A method for providing a battery cross-reference search, the method comprising:
receiving an input from a user interface to identify a battery based on at least one of battery chemistry, battery category, and battery number;
performing a battery lookup of a battery in a plurality of tables in a battery cross-reference database based on the input, wherein the plurality of tables comprise a stock number table, a battery model table, a battery chemistry table, a battery manufacturer table, a category table, a brand model table, a brand table, and a plurality of link tables; and
responsive to identifying a battery in the plurality of tables based on the input, returning a battery number of the battery from the database to the user interface.
